(19) United States
(12) Patent Application Publication
(10) Pub. No.: US 2015/0264034 A1
(43) Pub. Date: Sep. 17, 2015

(54) MULTI-LAYER AUTHENTICATION

(71) Applicant: Starbucks Corporation d/b/a Starbucks Coffee Company, Seattle, WA (US)

(72) Inventors: Lincoln C. Mongillo, III, Seattle, WA (US); Christopher J. Barrows, Kirkland, WA (US); Todd M. Parker, Somerville, MA (US); Patricia A. Toland, Quincy, MA (US)

(21) Appl. No.: 14/477,607

(22) Filed: Sep. 4, 2014

Related U.S. Application Data
(60) Provisional application No. 61/954,443, filed on Mar. 17, 2014.

(51) Int. Cl. H04L 29/06

(52) U.S. Cl. CPC H04L 63/083; H04L 63/0869; H04L 63/0861; H04L 2463/082

(57) ABSTRACT

The present disclosure relates to an interactive computing system utilizing a multi-layer authentication system having a primary authentication layer and a supplemental authentication layer. The interactive computing system can be a website, web application, a mobile application or other network-based system that provides content or services to a user. Illustratively, an interactive computing system could be a marketplace for purchasing products, a content service for accessing to streaming video content, a system for accessing network-based services of a retail location, such as food service provider, or other type of interactive service.

### INCORPORATION BY REFERENCE TO ANY PRIORITY APPLICATIONS

Any and all applications for which a foreign or domestic priority claim is made are identified in the Application Data Sheet as filed with the present application and are incorporated by reference under 37 CFR 1.57 and made a part of this specification.

### BACKGROUND

Generally described, computing devices and communication networks, such as the Internet, can be utilized to exchange information. In many situations, a user associated with a computing device may wish to access, or provide, information that is confidential or sensitive in nature. In an attempt to preserve the confidential nature of information, a content provider may attempt to authenticate the identity of users requesting access to information.

A widely used method for authentication of users on account-based websites requires interacting with users to collect credential information. For example, a content provider may provide an interface in which a requesting user can input username and password information. The content provider can make access to content dependent on validation of the submitted credential information. Accordingly, upon receipt of credential information, a content provider can determine whether the user's credential correspond to a valid user account. If a user's credentials do not correspond to a valid user account, access to the requested website is denied. If a user's credentials correspond to a valid user account, a connection can be established and the user can access the website.

In the typical authentication framework, a content provider will provide users will full access to content with a user account based on a successful validation of credential information. For example, a user may be able to purchase items from the website and access credit card information without requiring further authentication. However, often software application browsers utilized by a user may be configured to maintain credential information and automatically log the user into the website during subsequent account sessions. This can lead to security issues if a user leaves computer unattended, forgets to log out of an account on a public computer or misplaces a mobile phone.

### BRIEF DESCRIPTION OF THE DRAWINGS

FIG. 1 illustrates a block diagram depicting an illustrative embodiment of a computing environment for an interactive computing system.

FIG. 2 illustrates components of an embodiment of a user computing device.

FIGS. 3A-3E illustrate an embodiment of a user computing device that is configured to interact with an interactive computing system implementing a multi-layer authentication routine.

FIGS. 4A and 4B illustrate an embodiment of user interfaces on a user computing device for configuring multi-layer authentication.

FIG. 5 illustrates another embodiment of a user computing device that is configured to interact with an interactive computing system implementing a multi-layer authentication routine.

FIG. 6 is an embodiment of a flow diagram depicting an illustrative multi-layer authentication routine.

FIG. 7 is an embodiment of a flow diagram depicting an illustrative multi-layer authentication configuration routine.

### DETAILED DESCRIPTION

Generally described, the present disclosure relates to an interactive computing system utilizing a multi-layer authentication system having a primary authentication layer and a supplemental authentication layer. The interactive computing system interactive computing system can be a website, web application, a mobile application or other network-based system that provides content or services to a user. Illustratively, an interactive computing system could be a marketplace for purchasing products, a content service for accessing to streaming video content, a system for accessing network-based services of a retail location, such as food service establishment, or other type of interactive service.

The interactive computing system can use an account based system that requires a user to provide authentication credentials prior to accessing content and services of the interactive computing system. Different layers of authentication can be used to partition content and functionality on the interactive computing system. Illustratively, the interactive computing system can include a primary authentication layer and a supplemental authentication layer. In the primary authentication layer, a user can access a user account on the interactive computing system using primary authentication credentials, including an account identifier associated with the user account, such as a username, and a primary authentication key, such as a password. Successful authentication of the user account on the interactive computing system provides the user with access to a primary feature set associated with the primary authentication layer. The primary feature set defines content or functionality that is available for a user to access. The primary feature set can be used restrict access of the user to a portion of the content or functionality available to the user account and provided by of the interactive computing system.

The interactive computing system can be configured so that specific content or functions not included in the primary feature set are included in a supplemental feature set. The supplemental feature set defines content and/or functionality that are associated with a supplemental authentication layer. The primary feature set and supplemental feature set provide the user with access to different feature sets within the interactive computing system on a single user account. The primary and supplemental feature sets can be configured so that the content and functionality associated with each feature set are mutually exclusive and do not overlap. The interactive computing system can configure and modify the definitions of the primary feature set and supplemental feature set for each user account. In some instances, the user can influence how the primary feature set and supplemental feature set are defined.

The interactive computing system can be configured so that a supplemental feature set can only be accessed if the user provides supplemental authentication credentials. When a user requests access to content and/or functionality associated with the supplemental feature set, the user can be prompted to provide supplemental authentication credentials prior to receiving access. The supplemental authentication credentials are different from the primary authentication credentials. Unlike primary authentication, the supplemental authentication is already associated with the user account and the supplemental authentication credentials do not necessarily require an account identifier, such as a username. The supplemental authentication credentials can include a supplemental authentication key that is different than the primary authentication key. The supplemental authentication layer can utilize a type of authentication that is different than the authentication used for the primary authentication layer. For example, the primary authentication layer could require an eight character alphanumeric password and the supplemental authentication layer could require a four character numeric password or a biometric authentication key. After verifying the supplemental authentication credentials, the interactive computing system provides the user with access to the requested content and/or functionality associated with the supplemental feature set.

In some instances, the supplemental authentication layer may be an optional layer of authentication that is enabled by the user. The user can configure their user account with a supplemental authentication layer to increase security associated with access to the interactive computing system. Some users may not configure their accounts to utilize a supplemental authentication layer, in which case a user would have access to the entirety of the associated with their user account on the interactive computing system after providing primary authentication credentials. The supplemental authentication layer can be configured during account creation or could be enabled/disabled at a subsequent time.

In some instances, the interactive computing system can provide the user with the option to configure the content and/or functionality associated with the primary feature set and the supplemental feature set. Illustratively, a user may only enable supplemental authentication when utilizing a specific feature of the interactive computing system, such as accessing financial information associated with the user account, accessing account information, such as account subscriptions, a purchase above a defined total, or other feature of the interactive computing system. Illustratively, a user may provide access to their user account to multiple people, the user may use supplemental authentication to prevent the other people from accessing specific content or functions of the user account on the interactive computing system.

In an illustrative embodiment, an interactive computing system associated with a food service provider could provide a system for remotely ordering food. A user can remotely browse menu items, view prices, prepare a customized food order, select a food service location, submit the order to the food service provider and pay for the order. The primary feature set may be defined to exclude submitting and paying for the order. The functionality associated with submitting and paying for the order can be associated with a supplemental feature set associated with the supplemental authentication layer. The user would be required to provide supplemental authentication credentials prior to submitting and paying for the food order.

Although aspects of the present disclosure will be described with regard to an illustrative multi-layer authentication system, one skilled in the relevant art will appreciate that the disclosed embodiments are illustrative in nature and should not be construed as limiting. Still further, although a number of illustrative examples will be discussed with regard to the present disclosure, such examples should not necessarily be construed as limiting.

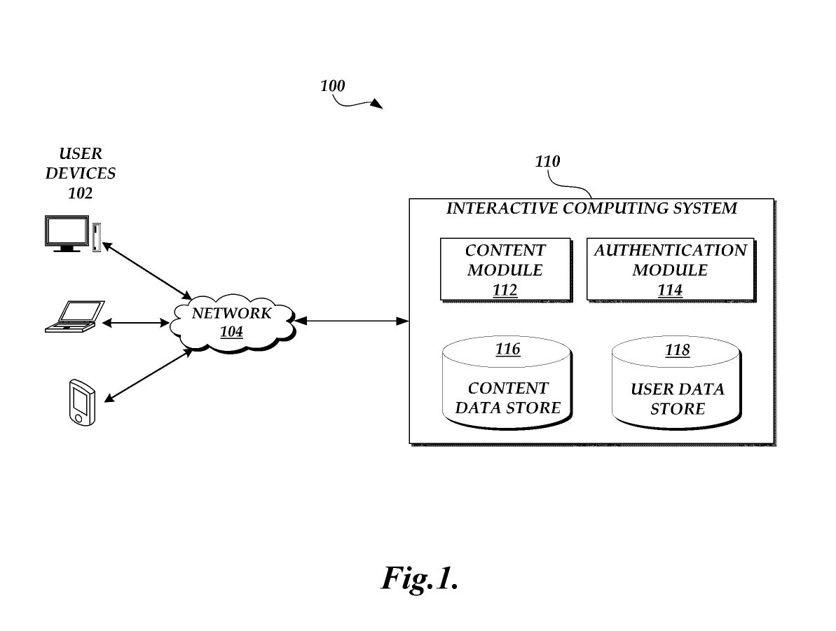

FIG. 1 illustrates an embodiment of a network environment 100 for an interactive computing system 110 configured to implement a multi-layer authentication system. In this embodiment, the network environment 100 includes a plurality of user devices 102 that can communicate with an interactive computing system 110 through a network 104.

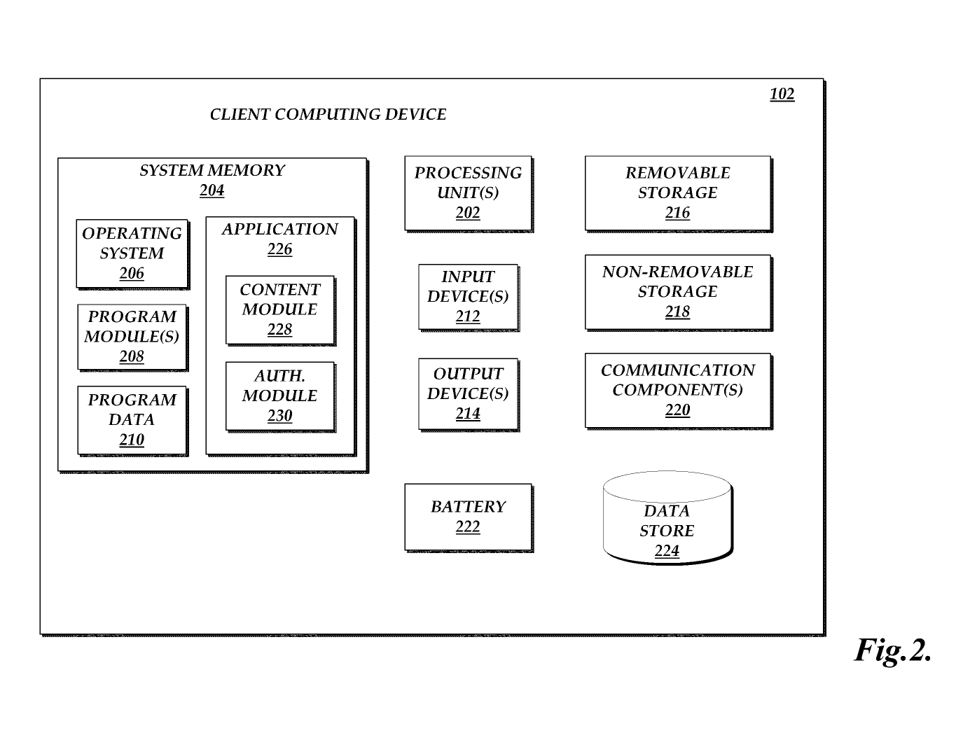

The user computing devices 102 can correspond to a wide variety of devices or components that are capable of initiating, receiving or facilitating communications over the communication network 104 including, but not limited to, personal computing devices, electronic book readers (e.g., e-book readers), hand held computing devices, integrated components for inclusion in computing devices, home electronics, appliances, vehicles, machinery, landline telephones, network-based telephones (e.g., voice over IP (“VoIP”), cordless telephones, cellular telephones, smart phones, modems, personal digital assistants, laptop computers, gaming devices, media devices, and the like. In an illustrative embodiment, the user computing devices 102 include a wide variety of software and hardware components for establishing communications over one or more communication networks, including wireless communication network, a wired communication network, or an IP-based telecommunication network. Illustrative components of a user computing device 102 will be described in greater detail with regard to FIG. 2.

The communication network 104 may be any wired network, wireless network or combination thereof. In addition, the communication network 104 may be a personal area network, local area network, wide area network, cable network, satellite network, cellular telephone network or combination thereof. Protocols and components for communicating via the Internet or any of the other aforementioned types of communication networks are well known to those skilled in the art of computer communications and thus, need not be described in more detail herein.

This embodiment of the interactive computing system 110 includes a content module 112, an authorization module 114, a content data store 116 and a user data store 118. The interactive computing system 110 may be implemented in hardware and/or software and may, for instance, include one or more servers having physical computer hardware configured to implement computer executable instructions for performing various features that will be described herein. The one or more servers may be geographically disbursed or geographically co-located, for instance, in one or more data centers.

The interactive computing system 110 can include servers, which can communicate with the user devices 102 over the network 104 and which can provide access to various services of the interactive computing system 110. The services of the interactive computing system 110 can be implemented by the content module 112 in conjunction with the authentication module 114. These services can be implemented in physical computer hardware on the servers or in separate computing devices. Moreover, the processing of the various components or services of the interactive computing system 110 can be distributed across multiple machines, networks, or other computing resources. The various components or services of the interactive computing system 110 can also be implemented in one or more virtual machines or hosted computing environment (e.g., “cloud”) resources, rather than in dedicated servers. Likewise, the data repositories shown can represent local and/or remote, physical and/or logical data storage, including, for example, storage area networks or other distributed storage systems. Executable code modules that implement various functionalities of the interactive computing system 110 can be stored in the content data store 116 and user data store 118 on memories of the servers and/or on other types of non-transitory computer-readable storage media. The interactive computing system 110 can be configured so that each of the components shown can communicate with any other components.

The content module 112 can implement the various functionalities and content available from the interactive computing system 110. The content module 112 can define each of the features, functionality and content that can be provided to a user interacting with the interactive computing system 110. The content module 112 can include executable code modules, for implementing the various functionalities of the interactive computing system 110. The content module 112 can also define the user interface and display parameters for the user to interface with the interactive computing system 110. The interactive computing system 110 can be an account-based system that provides a user with access to various content and functionalities after a user has created and logged into a user account. In some embodiments, interactive computing system 110 can provide some content and functionality to user that has not logged into a user account.

The content module 112 can define features sets. A feature set can be defined to include content, services and/or functions available on the interactive computing system. The feature sets can be used to partition content and/or functionality within the interactive computing system. Each feature set can be associated with an authentication layer. In one embodiment, there is a primary feature set and a supplemental feature set. The primary feature set is associated with a primary authentication layer. The content and/or functionality of the primary feature set are accessible after a user has accessed the interactive computing system through the primary authentication layer using primary authentication credentials. The content and/or functionality of the supplemental feature set are accessible after a user has successfully authenticated through a supplemental authentication layer using supplemental authentication credentials. In some embodiments, the interactive computing system can be configured such that the user can define a portion of the content and/or functionality included in each of the feature sets. In some embodiments, there can be three or more feature sets, with each feature set associated with a different authentication layer. Additionally, in other embodiments, the interactive computing system can be configured such that any one of the different authentication layer procedures can be repeated based on one or more factors including, but not limited to, frequency of access, time of access, amount of transaction, location information, or type of authentication.

For example, in one embodiment, the primary feature set includes content and functionality that allows a user to browse menu items and prepare a remote order for a food service provider. The supplemental feature set includes the functionality associated with authorizing payment and uploading the prepared order to the food service provider.

The content module 112 is in communication with the content data store 116. The content data store 116 can include any content or data associated with the operation and functionality of the interactive computing system. The content data store 116 can represent local and/or remote, physical and/or logical data storage, including, for example, storage area networks or other distributed storage systems.

The authorization module 114 can implement authentication protocols and processes for use in the interactive computing system. The authorization module 114 can provide verification of the primary authentication credentials and the supplemental authentication credentials. The authentication module 114 can define the authentication credentials used for each authentication layer. In some embodiments, the interactive computing system can have a primary authentication layer and a supplemental authentication layer. The authentication credentials associated with the primary authentication layer can include an authentication key and an account identifier. The authentication key can be further defined by an authentication type. Each type of authentication key can have associated authentication characteristics. The authentication characteristics associated with an authentication key type may include information that further defines the authentication key. In an exemplary embodiment, an authentication key type is an alphanumeric password. The authentication characteristics associated an alphanumeric password may include, the number of characters in the alphanumeric password (e.g., the password must be at least eight characters), types of characters in the password (e.g., the password must include at least one letter and one number), or characteristics defining the password. Each authentication key type can be associated with different authentication characteristics. The supplemental authentication layer has authentication credentials that include an authentication key, an authentication key type and associated authentication characteristics. The authentication type and/or characteristics of the supplemental authentication layer can be different than the primary authentication layer. For example, in some embodiments the primary authentication layer defines the account identifier as a username and the primary authentication key as an alphanumeric password, and the supplemental authentication layer defines the authentication key as a numeric password (e.g., a four digit numeric personal identification number (PIN)). The authentication type can be any authentication type defined by the authentication module 114. Non-limiting examples of authentication key types can include, but not limited to, alphanumeric character-based authentication keys, biometric authentication keys, image-based authentication keys and touch-based authentication keys. The authentication type can also be associated different levels of security and encryption. In some embodiments, the authentication module 114 can implement the various encryption and security protocols and processes associated with each authentication type.

Authentication information associated with a user for each authentication layer can be encrypted and stored in the user data store 118. The authentication module 114 can communicate with the user data store 118 during the authentication process to verify that the authentication credentials provided by the user matches the in authentication credentials stored in the user account.

The user data store 118 can store the user information associated with each user account of the interactive computing system. The user account information can include the user preferences, personal information, financial information, authentication credentials for each authentication layer, such as primary authentication credentials and supplemental authentication credentials. In some embodiments, the primary authentication credentials include a username and a first authentication key, and the supplemental authentication credentials include a second authentication key different from the first authentication key. In some embodiments, user preferences can include information associated with the different authentication layers, including enabling supplemental authentication, defining content and functionality associated with each layer, and other preferences. The financial information can include information such as credit card information, store card balances, or other financial information associated with the user account, such as recurring subscriptions.

FIG. 2 illustrates components of an embodiment of a user computing device 102, such as a mobile telephone. The user computing device 102 may include one or more processing units 202, such as one or more CPUs. The user computing device 102 may also include system memory 204, which may correspond to any combination of volatile and/or non-volatile computer-readable storage media. The system memory 204 may store information which provides an operating system module 206, various program modules 208, program data 210, and other modules. In some embodiments, an interactive computing system application 226 can be installed in system memory 204, program modules 208 and/or program data 210.

In some embodiments, the interactive computing system application 226 can include a content module 228 and an authentication module 230. The interactive computing system application 226 can be configured to implement at least a portion of the functionality of the content module 112 of the interactive computing system 110. In some embodiments, the interactive computing system application 226 can have the same functionality as the network-based interactive computing system 110. The interactive computing system application 226 can also be configured to store at least some of the information stored in the content data store 116 and the user data store 118 of the interactive computing system 110 on a local storage medium, such as a local data store.

The interactive computing system application 226 can be configured to communicate with the interactive computing system 110 in order to display content or perform functions that is not supported or stored locally on the user device 102. For example, an interactive computing system application 226 installed on a mobile device related to retail services or products may need to communicate with the interactive computing system 110 to identify the closest retail establishment associated with the application, update prices, inventory, wait times, or perform other functions relating to information not stored locally on the device. The interactive computing system application 226 may communicate with the data store of the interactive computing system 110 or an external data store to stream content or other data that is not locally stored on the device.

The content module 228 can manage feature sets on the interactive computing system application 226. The feature sets can be the same feature sets of the interactive computing system 110. In some embodiments, the feature sets may be different than the interactive computing system 110. The authorization module 230 can be configured to manage authentication of the authentication layers. The authorization module can communicate with the authorization module of the interactive computing system 110 to authenticate one or more authentication layers. In one embodiment, the authentication module 110 communicates with the interactive computing system 110 over the network for authentication of the primary authentication layer, and uses authentication credentials stored locally on the user device 102 for authentication of the supplemental authentication layer. In such embodiments, the authentication module 230 uses supplemental authentication credentials that is stored locally on the user device 102. This allows the application 226 to authenticate the supplemental authentication key without communicating with the interactive computing system over the network. In some embodiments, the supplemental authentication credentials are configured and stored on the user device and are not communicated or stored on the interactive computing system 110. In some embodiments, the supplemental authentication credentials may be stored on the user data store in the interactive computing system 110 and authenticated through the interactive computing system 110. The interactive computing system application 226 can provide access to a primary feature set after primary authentication and provide access to a supplemental feature set after supplemental authentication.

The user computing device 102 performs functions by using the processing unit(s) 202 to execute modules stored in the system memory 204. The user computing device 102 may also include one or more input devices 212 (keyboard, mouse device, specialized selection keys, etc.) and one or more output devices 214 (displays, printers, audio output mechanisms, etc.). One skilled in the relevant art will appreciate that additional or alternative software modules and/or hardware components may also be included in the user computing device 102 to carry out other intended functions such as mobile telephone functions.

With continued reference to FIG. 2, the user computing device 102 may also include a battery 222, one or more types of removable storage 216 and one or more types of non-removable storage 218. In some embodiments the device can be connected to an external power source, such as an AC power outlet. Still further, the user computing device 102 can include communication components 220, such as a cellular transceiver and a wireless transceiver, for facilitating communication via wired and wireless communication networks. These transceivers facilitate such communication using various communication protocols including, but not limited to, Bluetooth, the family of IEEE 802.11 technical standards (“WiFi”), the IEEE 802.16 standards (“WiMax), short message service (“SMS”), voice over IP (“VoIP”) as well as various generation cellular air interface protocols (including, but not limited to, air interface protocols based on code division multiplex access (CDMA), time division multiple access (TDMA), global system for mobile communications (GSM), wireband code division multiplex access (WCDMA), code division multiplex access 3^{rd} generation (CDMA1040), time division synchronous code division multiple access (TD-SCDMA), wavelength and time division multiple access (WTDMA), long term evolution (LTE), orthogonal frequency division multiple access (OFDMA), and similar technologies).

The above-enumerated list of components is representative and is not exhaustive of the types of functions performed, or components implemented, by the user computing device 102. One skilled in the relevant art will appreciate that additional or alternative components may also be included in the user computing device 102 to carry out other intended functions.

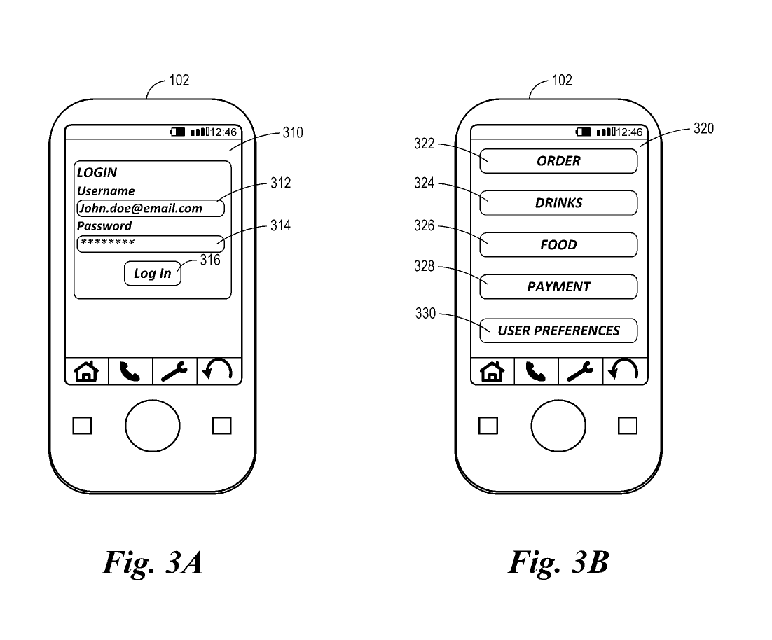

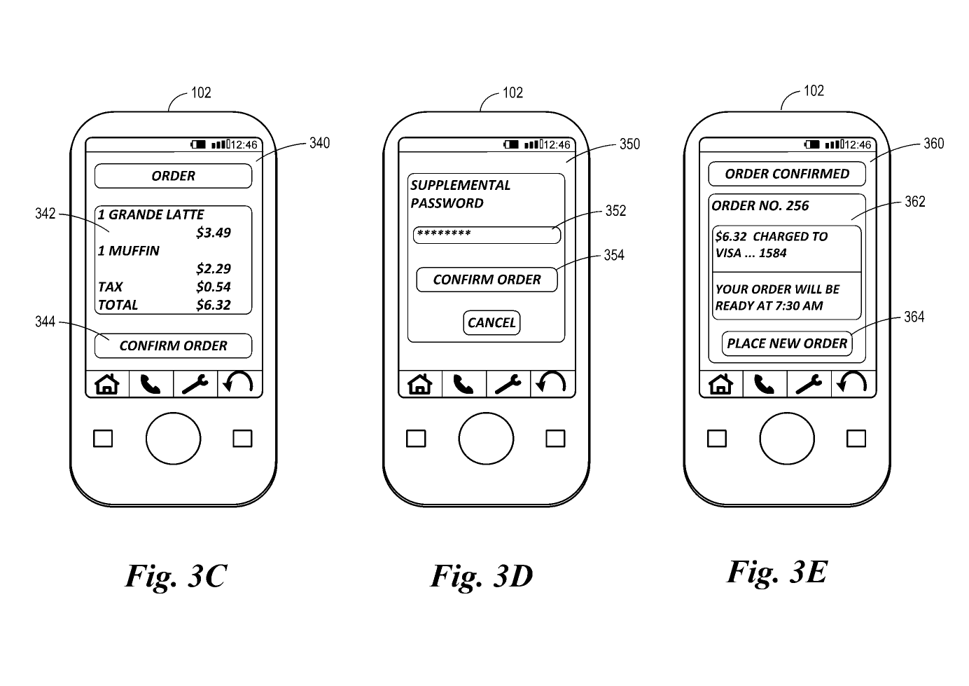

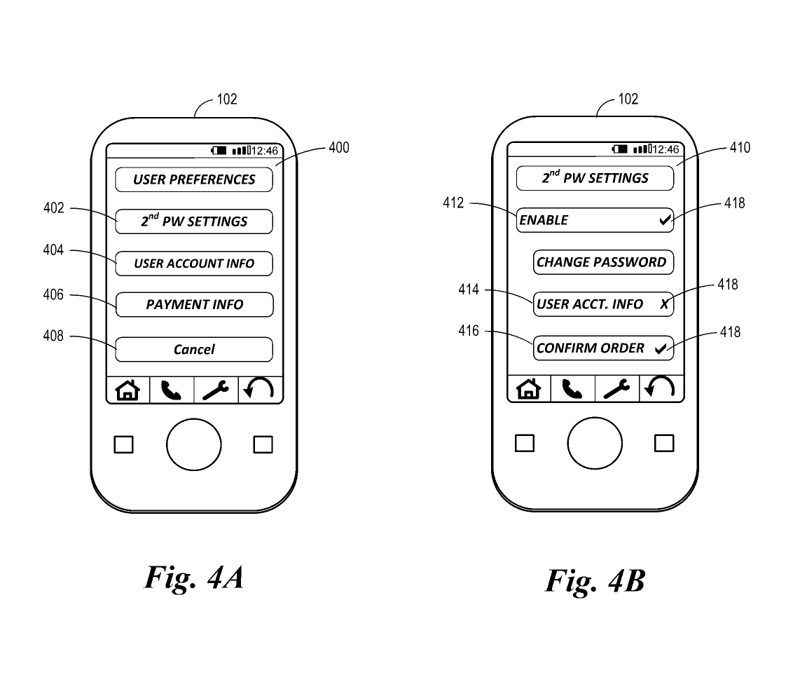

FIGS. 3A through 3E provide an illustrative embodiment of a user device 102 interacting with the interactive computing system 110 using multi-layer authentication. Content and functions associated with the different feature sets will be entirely dependent upon the configuration of the interactive computing system 110. Accordingly, the illustrated embodiment in FIGS. 3A through 3E are provided as illustrative examples of functionality that can be implemented by an interactive computing system 110 and do not limit the scope of this disclosure.

FIG. 3A illustrates a user interface 310 having a plurality of user inputs for a user to provide primary authentication credentials for accessing the interactive computing system 110. The login user interface 310 includes a plurality of primary authorization inputs, including a username input 312 and a password input 314. In this embodiment, the primary authentication credentials are a username and password. In other embodiments, the primary authentication layer may have different primary authentication credentials and/or use a different type of authentication, such as a biometric authentication. The primary authentication credentials associate the user computing device to a specific user account and provide the primary layer of authentication for the user account. The primary authentication credentials can be stored in the user data store 118 of the interactive computing system 110. In some embodiments, the primary authentication credentials can be stored locally in a data store on the user device 102.

When the user selects the login user input 316, the primary authentication credentials provided by the user to inputs 312 and 314 can be provided to the interactive computing system 110 for authentication. After the user device completes the primary authentication, the user device is logged into the interactive computing system 110 under the user account associated with the primary authentication credentials.

FIG. 3B illustrates a user interface 320 for displaying content provided by the interactive computing system 110 to the user device 102. The user interface 320 displays content user controls, including an order control 322, a drinks control 324, a food interface control 326, a payment control 328, and a user preferences control 330. Each of these controls can be assigned specific functions in accordance with the functionality assigned by the content module 112. The user has access to a primary feature set associated with the primary authentication. The content and functions associated with the primary feature set can be utilized by the user without restriction. However, content associated with a supplemental feature set cannot be accessed until the user provides authenticates using supplemental authentication credentials. In some embodiments, controls that are associated with a supplemental feature set can be displayed to the user, but cannot be accessed until the user provides the supplemental authentication credentials.

FIG. 3C illustrates a user interface 340 showing an order 342 created by the user. The order interface 340 illustrates content that is available in the user in the primary feature set. The order 342 includes a plurality of items selected by the user, a cost associated with the items and an order total. In this illustrative example, the primary feature set includes creating a remote order for a food service establishment. The user can access a menu, create one or more orders, and add or remove items from the proposed order. In this illustrative embodiment, the user may also be able to access other functions and information that is associated with the order, such as customizing the order, determining wait times, identifying the nearest food service establishment, and other functionality. After the user has completed the order, the user can decide to proceed with placing the order.

The functionality associated with placing the order is associated with a supplemental feature set. The user can select the confirm order input 344 in order to proceed with placing the order. When the user selects the confirm order input 344, the interactive computing system determines that the place order input is associated with the supplemental feature set. The selection of the user interface control 344 triggers the interactive computing system to display a request for supplemental authentication credentials illustrated in FIG. 3D. The user cannot proceed with the order until the supplemental authentication credentials are provided and verified.

FIG. 3D illustrates a supplemental authentication interface 350 requesting supplemental authentication credentials from the user. The supplemental authentication interface includes a supplemental authentication credentials input 352 and a control 354 for confirming the user's order. The supplemental authentication interface does not include an input associated with the identification of the user account because the supplemental authentication is already associated with the user account. After the user provides the supplemental authentication credentials, the authentication module can verify the authentication credentials. In some embodiments, the supplemental authentication credentials can be verified over the network based on the information stored in the user data store 118. In some embodiments the supplemental authentication credentials can be verified using locally stored information on the user device 102. The supplemental authentication credentials are different than the primary authentication credentials. The supplemental authentication can also use a different type of authentication, such as biometric authentication. In some embodiments, the primary authentication is an alphanumeric password and the supplemental authentication is different alphanumeric password. In embodiments where the supplemental authentication is stored locally on the user device, the authentication module can provide supplemental authentication without being connected to the interactive computing system 110.

FIG. 3E illustrates a user interface 360 showing an order confirmation. The confirmation interface 360 displays an order confirmation with supplemental information 362. The user interface provides an example of a successful implementation of a function associated with the supplemental feature set. In this illustrative embodiment, the user can proceed to place a new order using the input 364 provided. After the user has successfully provided the supplemental authentication, the user can access the content associated with the primary feature set and the supplemental feature set for the remainder of the session. In some embodiments, the interactive computing system may require that the user provide supplemental authentication every time content or functionality associated with the supplemental feature set is accessed.

FIGS. 4A and 4B illustrate example user devices for configuring multi-layer authentication within the interactive computing system. FIG. 4A illustrates a user preferences user interface screen 400. The user preferences screen 400 provides controls for supplemental authentication settings 402, user account information 404 and payment information 406. If a user account does not enable supplemental authentication, the user can have access to all of features sets of the interactive computing system. By enabling supplemental authentication the user can partition access to the content of the interactive computing system 110 according to the defined feature sets.

FIG. 4B illustrates a user interface 410 providing provides options for a user to enable and customize supplemental authentication. The user interface includes a control for enabling supplemental authentication 412, and various options for customizing the feature set associated with the supplemental authentication, including accessing user account information 414 and confirming an order 416. The indicators 418 illustrate whether the user has selected the associated control. In this embodiment, the user has enabled supplemental authentication for confirming the order but not for accessing user account information.

In some embodiments, the interactive computing system can allow for the user to define at least a portion of the functionality and content that is associated with a feature set. Depending on the configuration of the interactive computing system, the user may have more or less options for defining the functionality associated with each feature set. In the illustrated embodiment, there is a primary and supplemental feature sets associated with the primary authentication layer and the supplemental authentication layer. However, in other embodiments, there may be multiple features sets associated with different content. There may be multiple supplemental authentication layers, with each supplemental authentication layer having different supplemental authentication credentials and supplemental feature set.

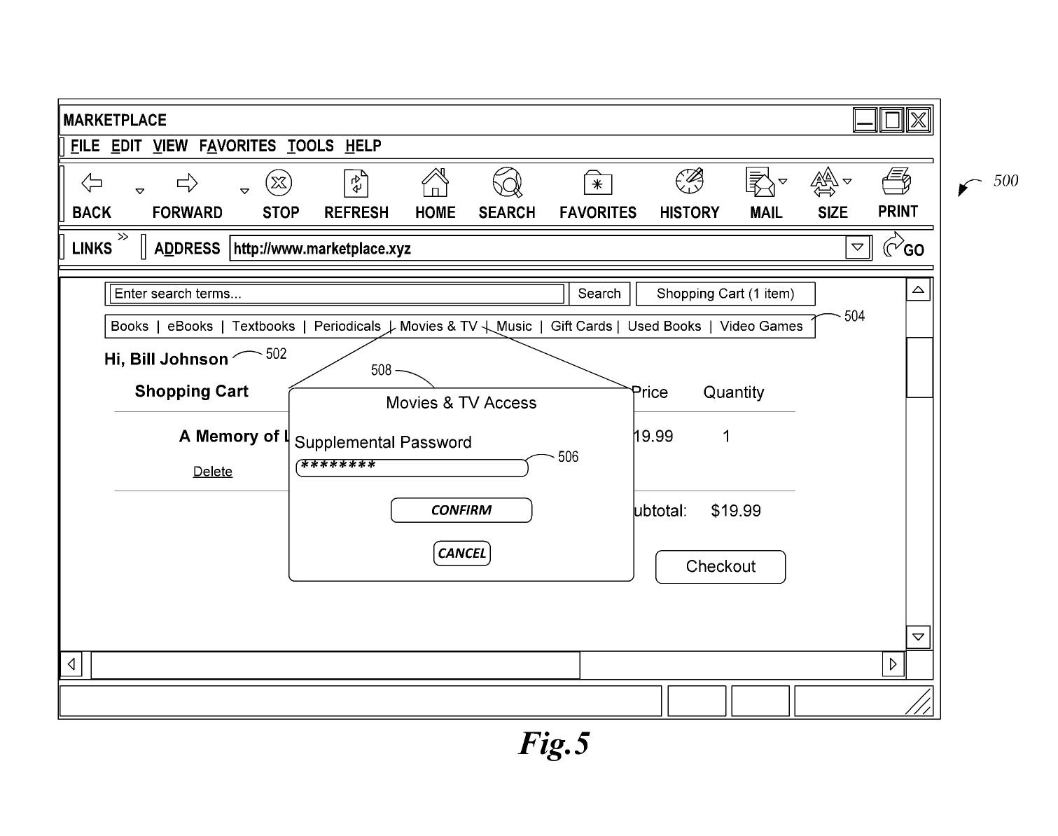

FIG. 5 illustrates an embodiment of another user interface 500 for an interactive computing system 110 that is implementing multi-layer authentication. In this embodiment of the interactive computing system, a user 502 has logged into a user account. The interactive computing system has a plurality of different categories 504 that can be selected by the user (e.g., Books, eBooks, Textbooks, Movies & TV, etc.). If the user selects a category that is related to a supplemental feature set, the interactive computing system requires that the user provide supplemental authentication credentials 506, such as the example illustrated in the prompt 508 when the user attempted to access the movies & TV category. The interactive computing system 110 can have multiple features sets associated with different content. There may be multiple supplemental authentication layers, with each supplemental authentication layer having different supplemental authentication credentials. For example, each category could be associated with a different supplemental feature set and a different supplemental authentication layer.

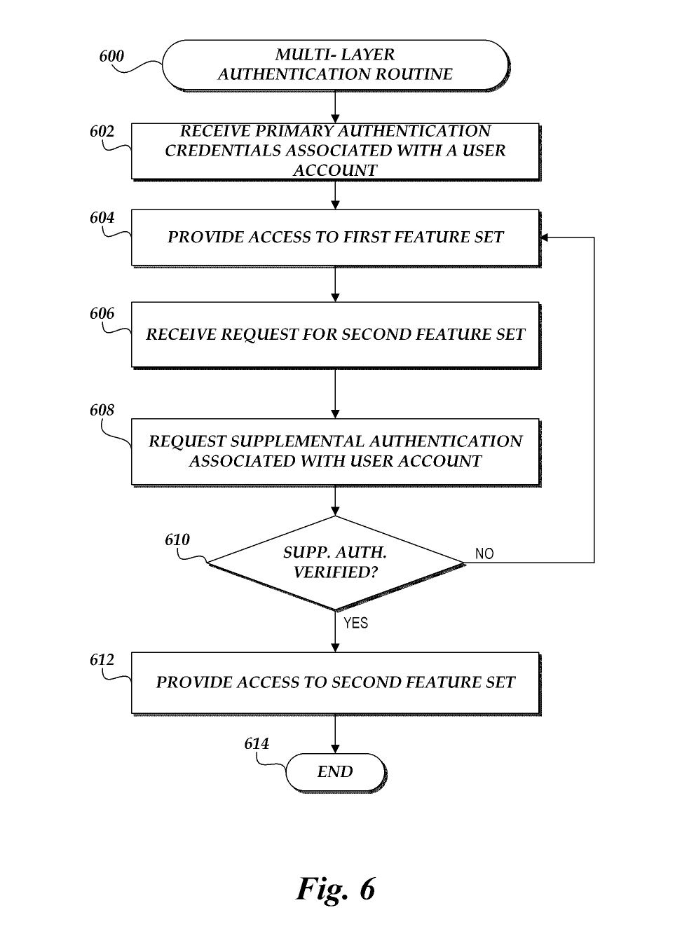

FIG. 6 illustrates a flowchart for a multi-layer authentication routine 600 in an interactive computing system 110. The multi-layer authentication routine 600 can be executed by interactive computing system 110. In some embodiments, the routine may be implemented in whole or in part by an interactive computing system application 226 on a user computing device 102.

At block 602 the interactive computing system receives primary authentication credentials associated with a user account. The primary authentication credentials can include an account identifier, such as a username associated with the user account, and an authentication key. In some embodiments, the identification of the user account may be based on information provided by the user device, such as a device identifier that is associated with the user account. The authentication key may be any type of authentication protocol defined by the interactive computing system 110. The interactive computing system verifies the primary authentication credentials provided by the user and provides access to a primary feature set at block 604.

At block 604, the interactive computing system provides access to the user to a primary feature set associated with the primary authentication layer. The primary feature set can include functionality and content provided by the interactive computing system. The primary feature set can be defined, at least in part by the interactive computing system. In some embodiments, primary feature set can be defined, at least in part, based on the information stored in the user account. The user can interact and utilize content and functionality of the primary feature set. The interactive computing system may allow the user to see or have access to information associated with a supplemental feature set. For example, the interactive computing system may provide user interface controls that allow the user to access the second set of features.

At block 606, the interactive computing system receives a request for content and/or functionality associated with the supplemental feature set. The request can come as part of a workflow that is being processed from the first set, such as a transaction, or other a selection made by the user of one or more controls for accessing the supplemental feature set.

At block 608, the interactive computing system requests supplemental authentication credentials from the user. The interactive computing system can provide an interface for the user to provide supplemental authentication credentials to the interactive computing system. The supplemental authentication credentials are different than the primary authentication credentials. In some embodiments it can be the supplemental same type of authentication, however, a different authentication key is used. In some embodiments, it is a different type of authentication. For example, the interactive computing system could use biometric authentication for the primary authentication and an alphanumeric password for supplemental authentication.

At block 610, the system verifies that the supplemental authentication credentials provided by the user are correct. If the authentication is verified, the routine proceeds to block 612. If the supplemental authentication is not verified, the routine proceeds to 604. The interactive computing system can verify that the provided supplemental authentication credentials match the supplemental authentication credentials stored in the user data store. In some embodiments, the supplemental authentication credentials can be verified using a local authentication module and verifying that the user-provided supplemental authentication credentials match the supplemental authentication credentials locally stored on the user device.

At block 612 the user after successfully completing the authentication key authentication can access the second set of features protected by the supplemental authentication layer. At block 614, the routine ends. Depending on the configuration of the interactive computing system, the user may be able to continue to access the supplemental feature set without providing the supplemental authentication credentials in the same user session.

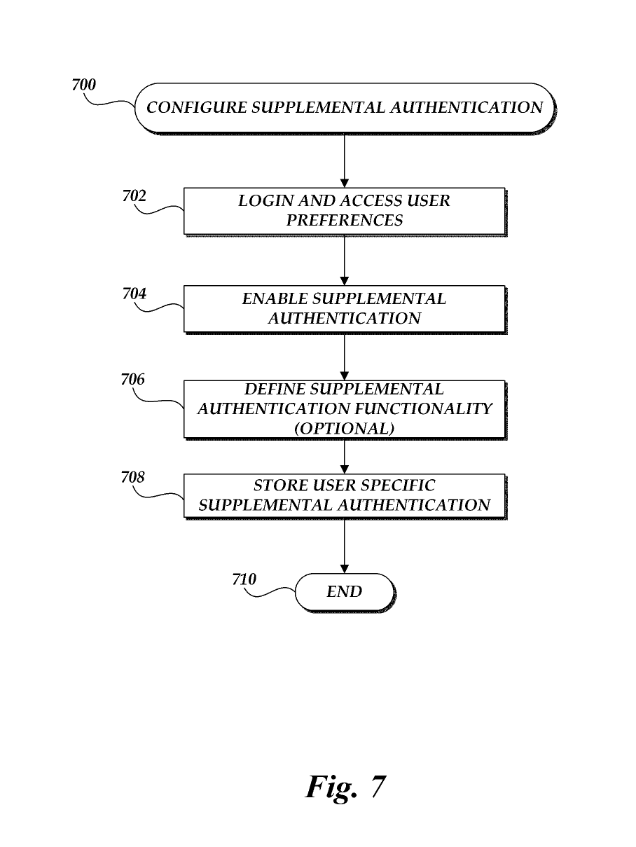

FIG. 7 illustrates a flowchart is shown that illustrates an embodiment of a process for configuring multi-layer authentication on a user account in an interactive computing system. The multi-layer authentication configuration routine 700 can be executed by interactive computing system 110. In some embodiments, the routine may be implemented in whole or in part by an interactive computing system application 226 on a user computing device 102.

At block 702 a user accesses a supplemental authentication configuration interface on the interactive computing system. The supplemental authentication configuration interface provides functionality for the user configure supplemental authentication associated with a user account. The configuration interface user can display and provide access to user account specific parameters or preferences. The configuration interface can be provided to the user at the time of user account creation or at some point after creation of the user account.

At block 704, the user can enable supplemental authentication for a user account. The user can enable supplemental authentication and provide the necessary supplemental authentication credentials defined by the interactive computing system. The supplemental authentication credentials are different from the primary authentication credentials. For example, the user primary authentication credentials may require different authentication keys of the same type (e.g., two different alphanumeric authentication keys) or different types of authentication (e.g., an alphanumeric authentication key and an image-based authentication key). The interactive computing system can be configured to verify that the primary authentication credentials and supplemental authentication credentials are different before enabling supplemental authentication.

At block 706, the user may optionally be able to define the feature set associated with the supplemental authentication. Depending on the configuration of the interactive computing system, the user may be able to define, at least in part, a supplemental feature set associated with the supplemental authentication. The interactive computing system may allow the user to associate specific content and or functions provided by the interactive computing system with a primary feature set or a supplemental feature set. In some embodiments, the user may be allowed to create a plurality of supplemental features sets. Each feature set can be associated with separate supplemental authentication credentials that can be defined as described in block 704. Depending on the configuration of the interactive computing system, the user can have more or less freedom to define the feature sets.

At block 708 the supplemental authentication credentials and user configuration options can be stored by the interactive computing system. The supplemental authentication credentials and/or configuration options can be stored in the user data store on the interactive computing system, or stored locally on a user device. In some embodiments the user configuration options can be stored in the user data store and the supplemental authentication credentials can be stored locally on a user device. At block 710, the routine ends.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm elements described in connection with the embodiments disclosed herein can be implemented as electronic hardware, computer software or combinations of both. To clearly illustrate this interchangeability of hardware and software, various illustrative components, blocks, modules and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A computer implemented method comprising:
as implemented by one or more computing devices configured with specific executable instructions,
receiving primary authentication credentials comprising a username and a first password, the username associated with a user account on an interactive computing system;
authenticating the primary authentication credentials by communicating with the interactive computing system over a network to verify that the first password is the same as a primary password stored in a user data store;
providing access to the user to content associated with a first feature set provided by the interactive computing system if the authentication is successful;
receiving a request from the user to access a function associated with a second feature set;
providing the user with an interface configured to receive supplemental authentication credentials from the user;
receiving supplemental authentication credentials from the user, wherein the supplemental authentication credentials comprise a second password that is different than the first password;
authenticating the supplemental authentication credentials by determining that the second password is same as a supplemental password stored in a data store on a user device; and
providing the user with access to the requested function associated with the second feature set.

2. The computer implemented method of claim 1, wherein the interactive computing system is associated with a service establishment.

3. The computer implemented method of claim 2 further comprising receiving input from the user device for creating an order for the purchase of products at the service establishment based on the content associated with the first feature set; and
wherein the function associated with the second feature set is payment for the order and providing the order to the service establishment.

4. The computer implemented method of claim 1, wherein the first password is an alphanumeric password and the second password is a numeric password.

5. The computer implemented method of claim 1, wherein the user device is a mobile device.

6. The computer implemented method of claim 1, wherein the interactive computing system is associated with a retail establishment.

7. A computer-readable, non-transitory storage medium storing computer executable instructions that, when executed by one or more computing devices, configure the one or more computing devices to perform operations comprising:
receiving primary authentication credentials comprising a username and a first authentication key, the username associated with a user account on an interactive computing system;
authenticating the primary authentication credentials by communicating with the interactive computing system over a network to verify that the first authentication key is the same as a primary authentication key;
providing content associated with a first feature set to the user if authentication of the primary authentication credentials is successful;
receiving a request from the user to access at least one of content and a function associated with a second feature set;
receiving supplemental authentication credentials from the user, wherein the supplemental authentication credentials include a second authentication key that is different from the first authentication key;
authenticating the supplemental authentication credentials by determining that the second authentication key is same as a supplemental authentication key stored in a data store on a user device; and
providing the user with access to the requested at least one of content and the function associated with the second feature set.

8. The storage medium of claim 7, wherein at least a portion of the content associated with the first feature set is stored in a local data store on the user device.

9. The storage medium of claim 7, wherein the user device is a mobile device.

10. The storage medium of claim 7, wherein the storage medium is an application configured to be installed on a mobile device.

11. The storage medium of claim 7, wherein the primary authentication key is stored in a user data store associated with the user account on the interactive computing system

12. The storage medium of claim 7, wherein the interactive computing system is associated with a food service establishment.

13. The storage medium of claim 7 wherein the first authentication key and the second authentication key are the same types of authentication keys.

14. The storage medium of claim 7 wherein the first authentication key and the second authentication key are different types of authentication keys.

15. The storage medium of claim 7, wherein the first authentication key is one of an alphanumeric authentication key, a numeric authentication key, a biometric authentication key, an image-based authentication key, and touch-based authentication key.

16. A system comprising:
an electronic data store configured to store user account data associated with each of a plurality of user accounts;
a computing system comprising one or more hardware computing devices, said computing system in communication with the electronic data store and configured to at least:
receive primary authentication credentials from a user computing device, wherein the primary authentication credentials comprise an account identifier associated with one of the plurality of user accounts and a first authentication key;
authenticate the primary authentication credentials by comparing the first authentication key to a primary authentication key stored in a user account of the electronic data store, wherein the user account is identified based, at least in part, on the account identifier;
receive a request to access at least one of content and a function associated with a supplemental feature set;
authenticate a second authentication key received from the user computing device by determining that the second authentication key is the same as a supplemental authentication key stored on the user computing device; and
provide the user computing device with access to the at least one of content and a function associated with a supplemental feature set based on the authentication of the supplemental authentication key from the user.

17. The system of claim 16, wherein at least a portion of the content associated with the first feature set is stored in a local data store on the user device.

18. The system of claim 16, wherein the user device is a mobile device.

19. The system of claim 16, wherein the storage medium is an application configured to be installed on a mobile device.

20. The system of claim 16, wherein the primary authentication key is stored in a user data store associated with the user account on the interactive computing system

21. The system of claim 16, wherein the interactive computing system is associated with a food service establishment.

22. The system of claim 16 wherein the first authentication key and the second authentication key are the same types of authentication keys.

23. The system of claim 16 wherein the first authentication key and the second authentication key are different types of authentication keys.

24. The system of claim 16, wherein the first authentication key is one of an alphanumeric authentication key, a numeric authentication key, a biometric authentication key, an image-based authentication key, and touch-based authentication key.
